(19) United States
(12) Patent Application Publication
(10) Pub. No.: US 2013/0135566 A1
(43) Pub. Date: May 30, 2013

(54) REFLECTIVE LIQUID CRYSTAL DISPLAY DEVICE AND METHOD OF MANUFACTURING THE SAME

(71) Applicants: Dongguan Masstop Liquid Crystal Display Co., Ltd, Dongguan City (CN); Wintek Corporation, Taichung City (TW)

(72) Inventors: Hsien-Wei Chiang, Taipei City (TW); Chih-Yuan Wang, Taichung City (TW)

(73) Assignees: WINTEK CORPORATION, Taichung City (TW); DONGGUAN MASSTOP LIQUID CRYSTAL DISPLAY CO., LTD., Dongguan City (CN)

(21) Appl. No.: 13/684,247

(22) Filed: Nov. 23, 2012

(30) Foreign Application Priority Data
Nov. 28, 2011 (TW) 100143539

(51) Int. Cl. G02F 1/1335; G02F 1/1341

(52) U.S. Cl. CPC G02F 1/133553; G02F 1/1341
USPC 349/104; 349/176; 445/25

(57) ABSTRACT

A manufacturing method of a reflective liquid crystal display device includes the following steps. Firstly, a first substrate and a second substrate are provided. A first channel, a second channel, and a third channel are formed between the first substrate and the second substrate. The first channel is filled with a first cholesteric liquid crystal. The second channel and the third channel are filled with a second cholesteric liquid crystal which includes a photoreactive cholesteric liquid crystal. An exposure process is then executed to modify the second cholesteric liquid crystal in the third channel into a third cholesteric liquid crystal.

### BACKGROUND OF THE INVENTION

1. Field of the Invention

The present invention relates to a reflective liquid crystal display device and a method of manufacturing the same, and more particularly to a reflective liquid crystal display device including at the same time the photoreactive cholesteric liquid crystal and the non-photoreactive cholesteric liquid crystal, and a method of manufacturing the same.

2. Description of the Prior Art

The reflective liquid crystal display device does not include a backlight module to serve as light source, so that the reflective liquid crystal display has the advantages of a thin structure and low power consumption. A cholesteric liquid crystal can selectively reflect a portion of light in a specific wavelength range, and stay in bistable state under the condition that no electrical voltage is applied. Accordingly, the cholesteric liquid crystal can be implemented in the reflective liquid crystal display device for better saving power properties.

The common manufacturing method of a single-layer color cholesteric liquid crystal display device includes a method of filling up the cholesteric liquid crystal, so as to reflect light with different specific wavelengths, such as the inkjet printing technology and the pixelized vacuum filling (PVF) technology, in order to achieve the full color display. But the inkjet printing technology has high equipment cost. The PVF technology may fill the cholesteric liquid crystals for reflecting light with different specific wavelength separately in order to avoid the contamination. But, the repetition of the filling processes of the cholesteric liquid crystal, the package shape of the channels, the sealing and cutting processes would complicate the manufacturing process and adversely affect the yield.

Accordingly, additives for inducing the photoreactive characteristic of the cholesteric liquid crystal have been developed. In other words, after the exposure to light with proper wavelength and proper energy, such as ultraviolet, the cholesteric liquid crystal used to reflect blue light may be modified to reflect red or green light. Therefore, the cholesteric liquid crystal having the photoreactive characteristics used in the PVF technology can simplify the manufacturing process of the PVF technology. However, the reflectivity of the cholesteric liquid crystal having the photoreactive characteristics is not as good as the reflectivity of the cholesteric liquid crystal without the photoreactive characteristic. Consequently, how to use the cholesteric liquid crystal having the photoreactive characteristics effectively and meanwhile ensure the quality of the reflective liquid crystal display device is still an important issue in this field.

### SUMMARY OF THE INVENTION

An objective of the present invention is therefore to provide a reflective liquid crystal display device and a method of manufacturing the same. The filling of the photoreactive cholesteric liquid crystal and the non-photoreactive cholesteric liquid crystal can simplify the manufacturing process and improve the display properties.

According to one exemplary embodiment of the present invention, a method of manufacturing a reflective liquid crystal display device includes the following steps. A first substrate and a second substrate are provided, and a patterned separation structure is formed on the first substrate or on the second substrate. Then, the first substrate and the second substrate are combined to dispose the patterned separation structure between the first substrate and the second substrate, and a first channel having a first injection inlet, a second channel having a second injection inlet and a third channel having a third injection inlet are formed. Subsequently, the first channel is filled with a first cholesteric liquid crystal through the first injection inlet, the first injection inlet is later sealed, and the first cholesteric liquid crystal is used to reflect a first primary color. The second channel and the third channel are respectively filled with the second cholesteric liquid crystal through the second injection inlet and the third injection inlet, the second injection inlet and the third injection inlet are later sealed; the second cholesteric liquid crystal is used to reflect a second primary color, and includes a photoreactive cholesteric liquid crystal. Furthermore, an exposure process is performed on the second cholesteric liquid crystal in the third channel for modifying the second cholesteric liquid crystal in the third channel into a third cholesteric liquid crystal, in which the third cholesteric liquid crystal is used to reflect a third primary color.

According to another exemplary embodiment of the present invention, a reflective liquid crystal display device is provided. The reflective liquid crystal display device includes a first substrate, a second substrate, a first electrode, a second electrode, a patterned separation structure, a first cholesteric liquid crystal and a second cholesteric liquid crystal. The second substrate is disposed oppositely to the first substrate. A first inner surface of the first substrate and a second inner surface of the second substrate face each other. The first electrode is disposed on the first inner surface of the first substrate, and the second electrode is disposed on the second inner surface of the second substrate. The patterned separation structure is disposed between the first substrate and the second substrate to form a first channel and a second channel. The first cholesteric liquid crystal is used to reflect a first primary color, and the first cholesteric liquid crystal includes a non-photoreactive cholesteric liquid crystal. The second cholesteric liquid crystal is used to reflect a second primary color, and the second cholesteric liquid crystal includes a photoreactive cholesteric liquid crystal.

In the present invention, the photoreactive cholesteric liquid crystal and the non-photoreactive cholesteric liquid crystal are simultaneously implemented in the reflective liquid crystal display device. The photoreactive cholesteric liquid crystal is beneficial for the simplification of the manufacturing process, and the non-photoreactive cholesteric liquid crystal can enhance the display properties of the reflective liquid crystal display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 through FIG. 9 are schematic diagrams illustrating a method of manufacturing a reflective liquid crystal display device according to a preferred exemplary embodiment of the present invention.

### DETAILED DESCRIPTION

To provide a better understanding of the present invention, preferred exemplary embodiments will be described in detail herein. The preferred exemplary embodiments of the present invention are illustrated in the accompanying drawings with numbered elements.

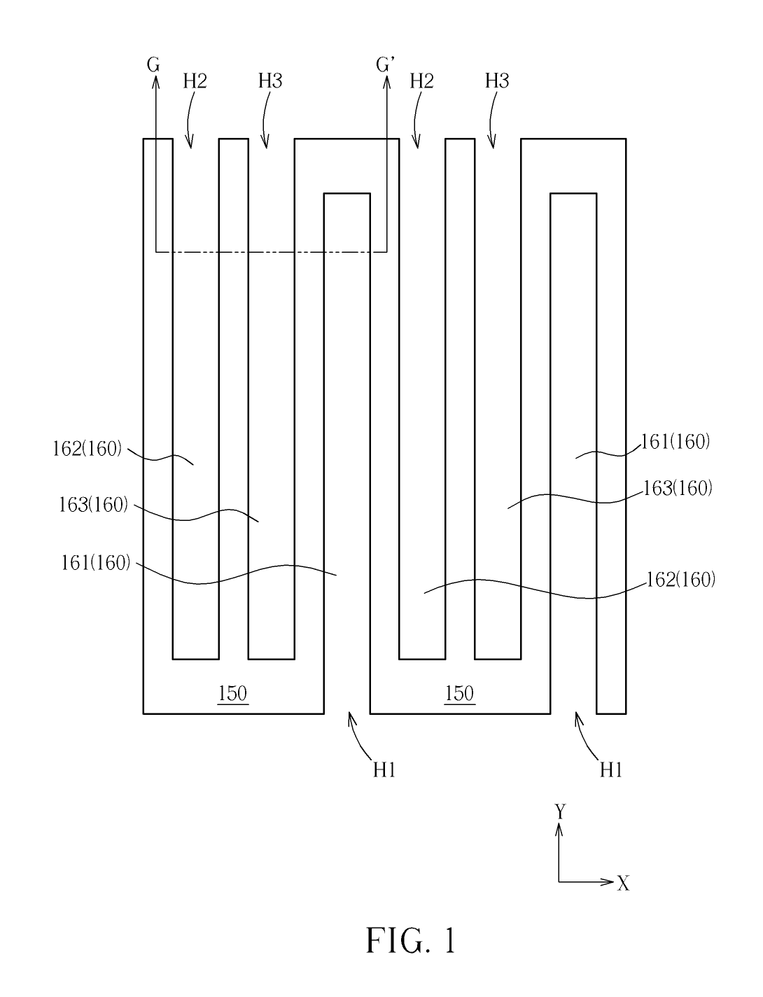

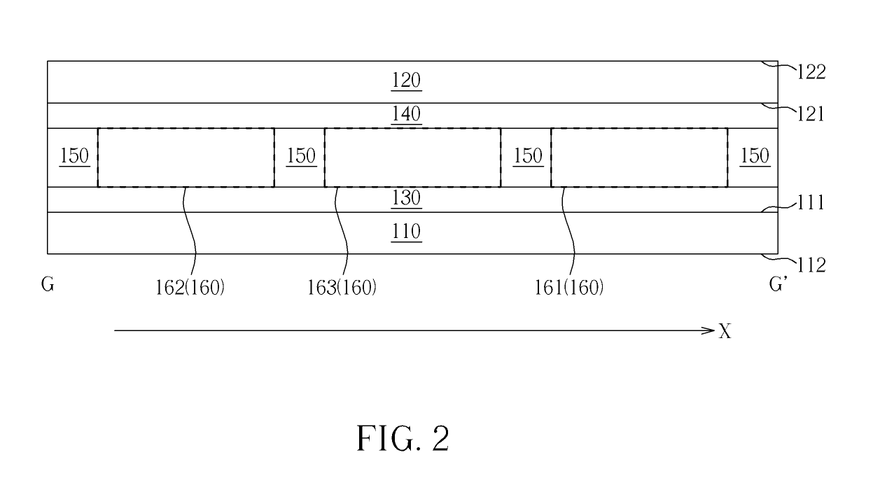

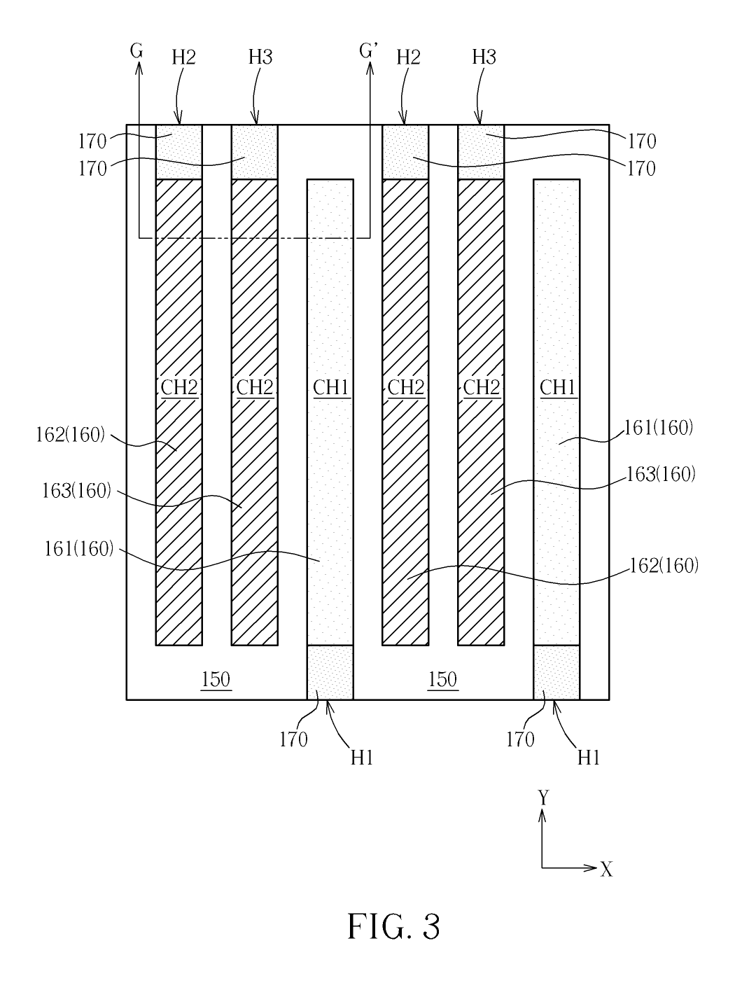

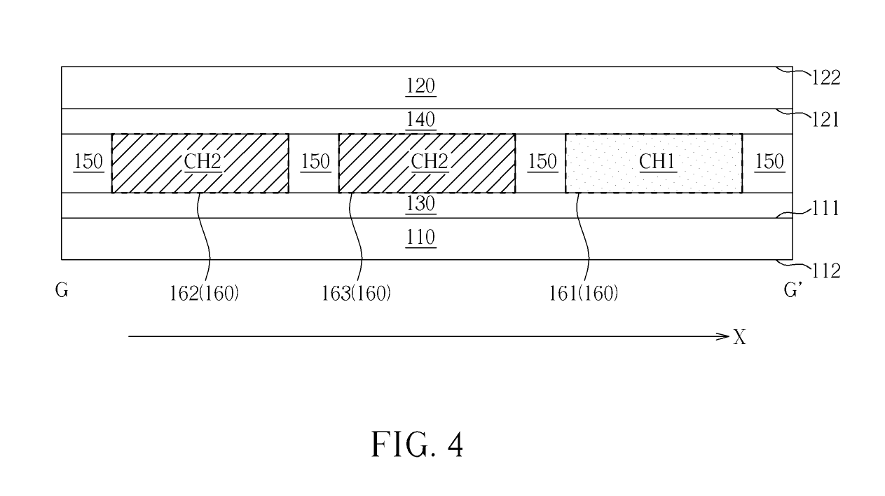

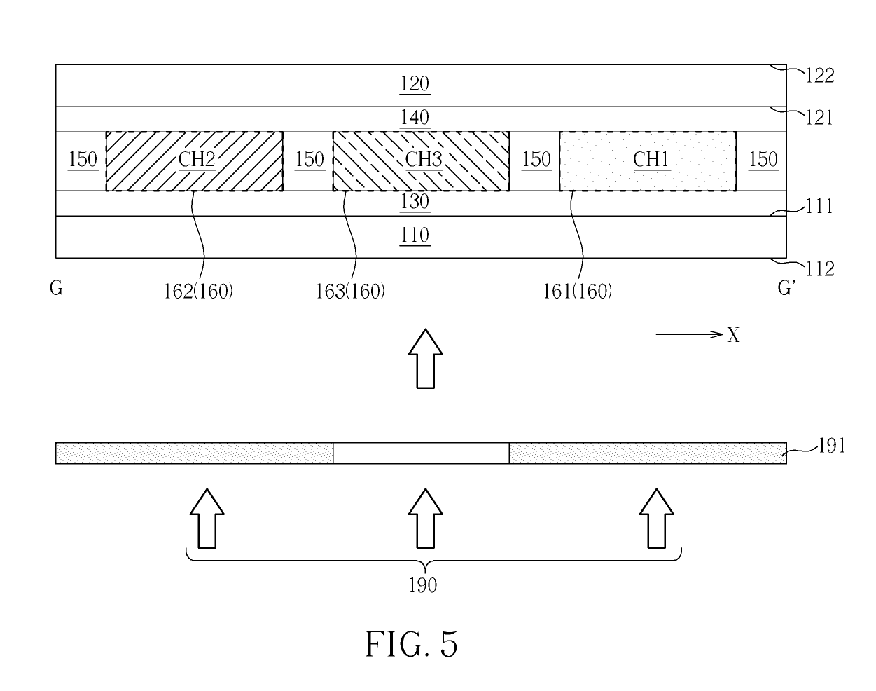

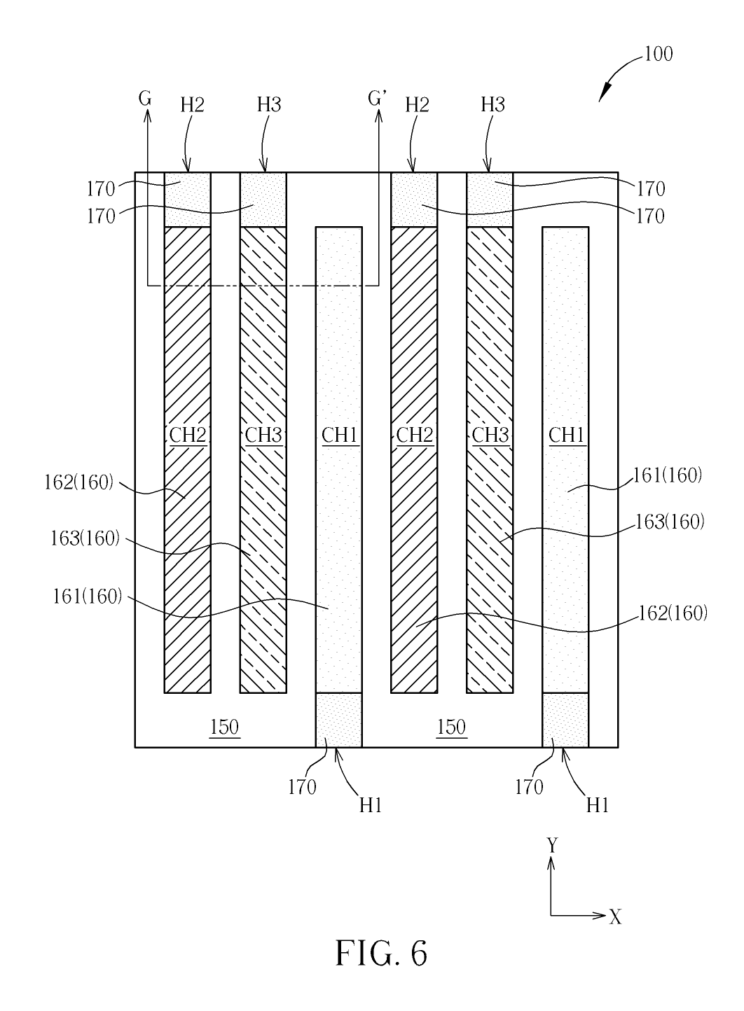

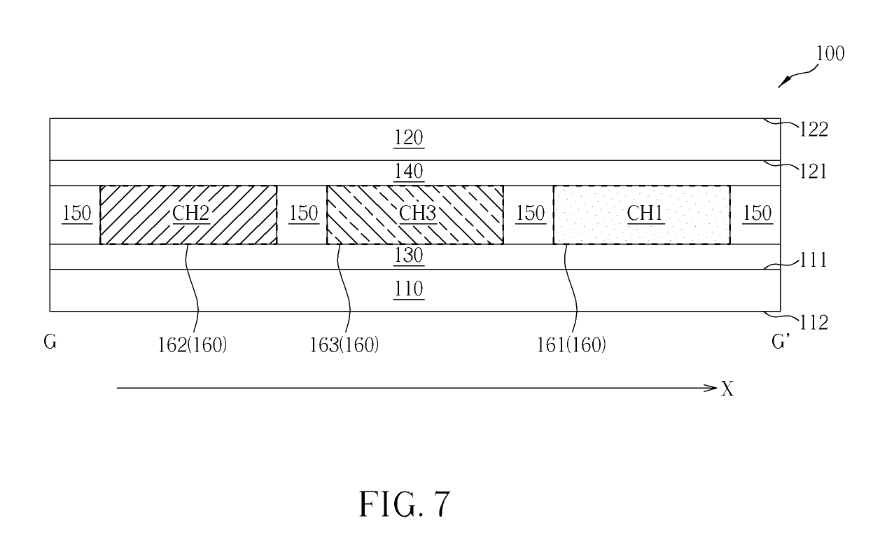

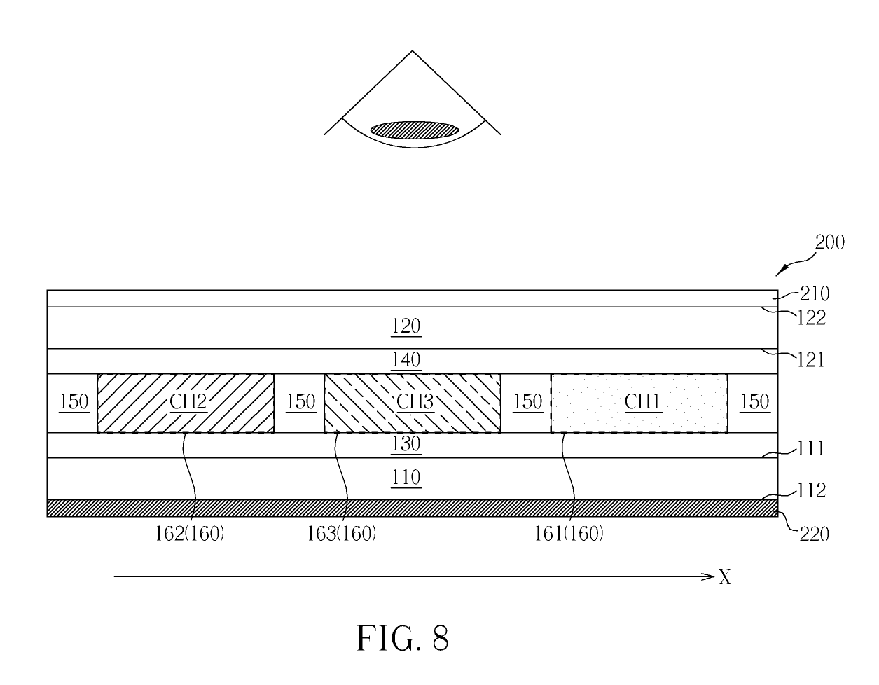

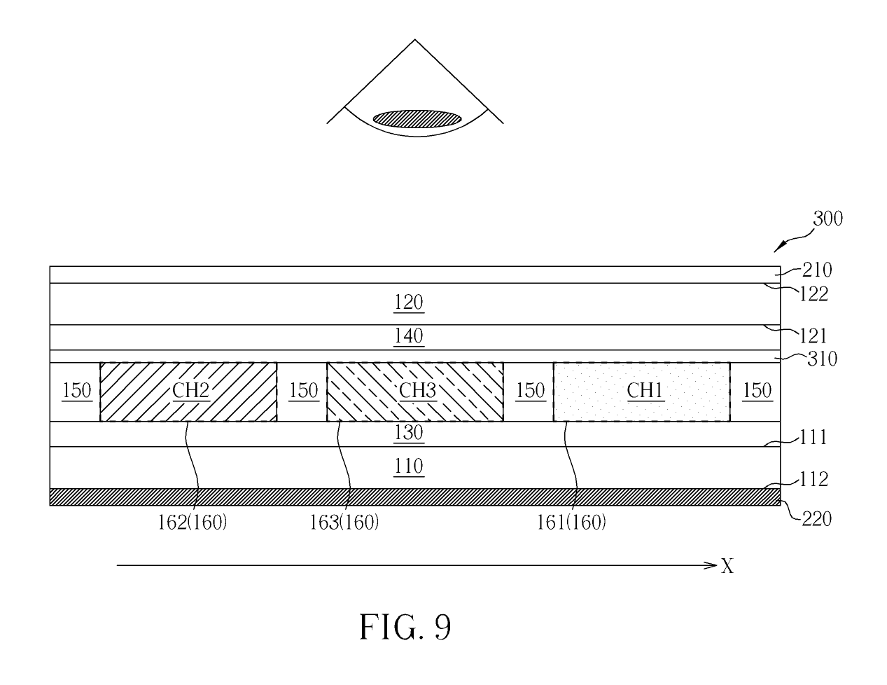

Please refer to FIG. 1 through FIG. 9. FIG. 1 through FIG. 9 are schematic diagrams illustrating a method of manufacturing a reflective liquid crystal display device according to a preferred exemplary embodiment of the present invention. FIG. 1, FIG. 3, FIG. 6 are top view illustrating the method of manufacturing the reflective liquid crystal display device, and FIG. 2, FIG. 4, FIG. 5, FIG. 7, FIG. 8, FIG. 9 are cross-sectional views illustrating the method of manufacturing the reflective liquid crystal display device. FIG. 2 is a cross-sectional view taken along the line G-G′ of FIG. 1, FIG. 4 is a cross-sectional view taken along the line G-G′ of FIG. 3, and FIG. 7 is a cross-sectional view taken along the line G-G′ of FIG. 6. The drawings are schematic diagrams to help understanding the present invention, and the real scale can be adjusted, based on the design demand.

According to one exemplary embodiment of the present invention, a method of manufacturing a reflective liquid crystal display device including the following steps is provided. As shown in FIG. 1 and FIG. 2, at first, a first substrate 110 and a second substrate 120 are provided. The first substrate 110 has a first inner surface 111 and a first outer surface 112, and the second substrate 120 has a second inner surface 121 and a second outer surface 122. The first substrate 110 and the second substrate 120 may include glass substrate, polyethylene terephthalate (PET) substrate, polyethersulfone (PES) substrate, or polyimide (PI) substrate, but not limited thereto, other substrates made of other proper material can also be used in the present invention. Then, a first electrode 130 is formed on the first inner surface 111, and a second electrode 140 is formed on the second inner surface 121. In this exemplary embodiment, the first electrode 130 and the second electrode 140 could be made of transparent conductive material such as indium tin oxide (ITO), indium zinc oxide (IZO), aluminum zinc oxide (AZO), zinc oxide, or tin oxide, but not limited thereto. Subsequently, a patterned separation structure 150 is formed on the first inner surface 111 of the first substrate 110 or on the second inner surface 121 of the second substrate 120. The patterned separation structure 150 may include materials such as epoxy, acrylic or other proper materials, and the manufacturing process of the patterned separation structure 150 may include a printing process, a photolithography process, or other proper processes, but not limited thereto. Afterwards, the first substrate 110 and the second substrate 120 are combined for disposing the patterned separation structure 150 between the first substrate 110 and the second substrate 120 to form a plurality of channels 160. The channels 160 include a first channel 161 having a first injection inlet H1, a second channel 162 having a second injection inlet H2 and a third channel 163 having a third injection inlet H3. In this exemplary embodiment, each channel 160 is a straight channel extending along a second direction Y, and the first channel 161, the second channel 162 and the third channel 163 are disposed alternately along a first direction X. The shape and the disposition of the channels 160 are not limited to those illustrated. Additionally, the patterned separation structure 150 may further include a glue material to paste the first substrate 110 and the second inner surface 121, in order to simplify the manufacturing process. A thickness of the patterned separation structure 150 is preferably and substantially smaller than or equal to 30 micrometers (μm) so as to control the space of each channel 160, but not limited thereto.

As shown in FIG. 3 and FIG. 4, a first cholesteric liquid crystal CH1 is filled into the first channel 161 through the first injection inlet H1, and the first injection inlet H1 is later sealed. Moreover, a second cholesteric liquid crystal CH2 is filled into the second channel 162 and the third channel 163 respectively through the second injection inlet H2 and the third injection inlet H3, and the second injection inlet H2 and the third injection inlet H3 are later sealed. It is appreciated that, an opening direction of the first injection inlet H1 is preferably different from an opening direction of the second injection inlet H2 and an opening direction of the third injection inlet H3, in this exemplary embodiment, for example, the opening direction of the second injection inlet H2 and the opening direction of the third injection inlet H3 are toward the second direction Y, while the opening direction of the first injection inlet H1 is toward a reverse direction of the second direction Y, in order to avoid the contamination during each filling process of each cholesteric liquid crystal. The opening direction of the injection inlet could be adjusted to meet the process demands. In addition, a sealing material 170 is used to respectively seal the first injection inlet H1, the second injection inlet H2 and the third injection inlet H3. The sealing material 170 includes a photo-curable material or a thermal-curable material, but not limited thereto. In this exemplary embodiment, the first cholesteric liquid crystal CH1 could be used to reflect a first primary color, such as blue, and the second cholesteric liquid crystal CH2 could be used to reflect a second primary color, such as green. The primary color reflected by the first cholesteric liquid crystal CH1 or the second cholesteric liquid crystal CH2 is not limited thereto. The second cholesteric liquid crystal CH2 may include photoreactive cholesteric liquid crystal, in other words, the second cholesteric liquid crystal CH2 is cholesteric liquid crystal that is reactive to light. In addition, the second cholesteric liquid crystal CH2 of this exemplary embodiment has the characteristic of being light reactive to ultraviolet, i.e. the second cholesteric liquid crystal CH2 can be modified into a cholesteric liquid crystal reflecting light of a different wavelength range after exposure to ultraviolet light having adequate energy, but not limited thereto.

As shown in FIG. 5 through FIG. 7, an exposure process 190 is performed on the second cholesteric liquid crystal CH2 in the third channel 163, and the second cholesteric liquid crystal CH2 in the third channel 163 is modified into a third cholesteric liquid crystal CH3. The third cholesteric liquid crystal CH3 is used to reflect a third primary color such as red, but not limited thereto. For example, in this exemplary embodiment, a mask 191 is used to execute the exposure process 190, and an ultraviolet illuminant exposes the second cholesteric liquid crystal CH2 in the third channel 163 through the first substrate 110, accordingly, only the second cholesteric liquid crystal CH2 in the third channel 163 is modified into the third cholesteric liquid crystal CH3, and the second cholesteric liquid crystal CH2 in the second channel 162 can be protected from the influence of the exposure process 190. Furthermore, the first cholesteric liquid crystal CH1 is preferably a non-photoreactive cholesteric liquid crystal, i.e. the first cholesteric liquid crystal CH1 of this exemplary embodiment preferably is not reactive to light, in order to possess the best light reflection properties. The present invention may also be implemented with the first cholesteric liquid crystal CH1 being reactive to light, in order to meet the requirement of the manufacturing process or the specifications of the production. Additionally, in the exposure process 190, the ultraviolet illuminant is not limited to expose the second cholesteric liquid crystal CH2 in the third channel 163 through the first substrate 110; the ultraviolet illuminant could also expose the second cholesteric liquid crystal CH2 in the third channel 163 through the second substrate 120 for example.

As shown in FIG. 8, in this exemplary embodiment, the method of manufacturing the reflective liquid crystal display device further includes forming a light absorbent layer 220 on the first outer surface 112 of the first substrate 110 and forming an ultraviolet barrier layer 210 on the second outer surface 122 of the second substrate 120. The light absorbent layer 220 is used to absorb the light that penetrates through the first cholesteric liquid crystal CH1, the second cholesteric liquid crystal CH2 and the third cholesteric liquid crystal CH3, to prevent the display properties of the light reflected by the first cholesteric liquid crystal CH1, the second cholesteric liquid crystal CH2 and the third cholesteric liquid crystal CH3 from being affected by the illustrated penetrating light. Therefore, the display quality of the reflective liquid crystal display could be improved. Moreover, it is appreciated that the ultraviolet barrier layer 210 is used to filter the ultraviolet light or light in the specific wavelength range, in order to prevent the second cholesteric liquid crystal CH2 that is light reactive, the third cholesteric liquid crystal CH3 or the first cholesteric liquid crystal CH1 from being exposed by the illustrated light again, so that the display quality and the reliability of the reflective liquid crystal display could be enhanced. It is further noticed that, the second outer surface 122 of the second substrate 120 could be a display surface; accordingly, the ultraviolet barrier layer 210 may be formed on the second outer surface 122, and the light absorbent layer 220 may be formed on the first outer surface 112. In other exemplary embodiments, the ultraviolet barrier layer 210 may be formed on the first outer surface 112, and the light absorbent layer 220 may be formed on the second outer surface 122 according to the predetermined location of the display surface. Furthermore, the second substrate 120 could also be an ultraviolet barrier substrate, and the ultraviolet barrier layer 210 could be selectively omitted.

As shown in FIG. 9, the method of manufacturing the reflective liquid crystal display device further includes forming an adhesive layer 310 on the second inner surface 121 before combining the first substrate 110 and the second substrate 120 in order to strengthen the pasting of the first substrate 110 and the second substrate 120. The adhesive layer 310 could be made of epoxy, acrylic or other adequate and adhesive transparent material. It is appreciated that, the adhesive layer 310 could also be formed on the first inner surface 111 before combining the first substrate 110 and the second substrate 120.

Please refer to FIG. 6 and FIG. 7 again. FIG. 6 through FIG. 7 are schematic diagrams illustrating a reflective liquid crystal display device according to a preferred exemplary embodiment of the present invention. FIG. 6 is top view illustrating the reflective liquid crystal display device, and FIG. 7 is a cross-sectional view taken along the line G-G′ of FIG. 6. As shown in FIG. 6 and FIG. 7, a reflective liquid crystal display device 100 includes a first substrate 110, a second substrate 120, a first electrode 130, a second electrode 140, a patterned separation structure 150, a first cholesteric liquid crystal CH1 and a second cholesteric liquid crystal CH2. The second substrate 120 is disposed oppositely to the first substrate 110. The first substrate 110 has a first inner surface 111 and a first outer surface 112, the second substrate 120 has a second inner surface 121 and a second outer surface 122, and the first inner surface 111 and the second inner surface 121 face each other. A first electrode 130 is disposed on the first inner surface 111 of the first substrate 110, and a second electrode 140 is disposed on the second inner surface 121 of the second substrate 120. A patterned separation structure 150 is disposed between the first substrate 110 and the second substrate 120 to form a plurality of channels 160 including a first channel 161, a second channel 162 and a third channel 163 between the first substrate 110 and the second substrate 120. In this exemplary embodiment, the first cholesteric liquid crystal CH1 disposed in the first channel 161 is used to reflect a first primary color such as blue, but not limited thereto. The first cholesteric liquid crystal CH1 may preferably be a non-photoreactive cholesteric liquid crystal, i.e. the first cholesteric liquid crystal CH1 may preferably not be light reactive. The second cholesteric liquid crystal CH2 disposed in the second channel 162 is used to reflect a second primary color such as green, but not limited thereto. The second cholesteric liquid crystal CH2 may preferably be a photoreactive cholesteric liquid crystal, i.e. the second cholesteric liquid crystal CH2 may preferably be light reactive. More specifically, the second cholesteric liquid crystal CH2 can be modified into a cholesteric liquid crystal reflecting light in a different wavelength range after exposure to light, such as ultraviolet having adequate energy, but not limited thereto. Additionally, the reflective liquid crystal display device 100 further includes a third cholesteric liquid crystal CH3 disposed in the third channel 163, and the third cholesteric liquid crystal CH3 could be used to reflect a third primary color such as red, but not limited thereto. The third cholesteric liquid crystal CH3 may preferably be a photoreactive cholesteric liquid crystal, i.e. the third cholesteric liquid crystal CH3 may preferably be light reactive. More specifically, the third cholesteric liquid crystal CH3 can also be modified into a cholesteric liquid crystal reflecting light in a different wavelength range after exposure to light such as ultraviolet having adequate energy, but not limited thereto.

In this exemplary embodiment, the first cholesteric liquid crystal CH1, the second cholesteric liquid crystal CH2 and the third cholesteric liquid crystal CH3 are respectively disposed in the first channel the first channel 161, the second channel 162 and the third channel 163. Furthermore, the first channel 161, the second channel 162 and the third channel 163 are disposed alternately along a first direction X. In the reflective liquid crystal display device 100, the electric status between the first electrode 130 and the second electrode 140 may be adjusted, so that the first cholesteric liquid crystal CH1, the second cholesteric liquid crystal CH2 and the third cholesteric liquid crystal CH3 may reflect light of different primary colors, and the reflecting light could be further mixed to achieve a full color display. The material of the first cholesteric liquid crystal CH1, the second cholesteric liquid crystal CH2 and the third cholesteric liquid crystal CH3 may include cholesteric liquid crystal monomer, colouring agent, chiral dopant or polymer mixture, but not limited thereto. The illustrated chiral dopant may include cyano-chiral dopant, cholesteryl nonanote chiral dopant, nonracemic chiral dopant, macromolecular helicity chiral dopant, azobenzenes chiral dopant, ZLI chiral dopant, binaphthalene chiral dopant, dipolar chiral dopant, SPE chiral dopant or other adequate chiral dopants. The illustrated polymer mixture may have the characteristics of photo-curable or thermal-curable, and the polymer mixture may include monofunctional monomer, multifunctional monomer, monofunctional oligomer, multifunctional oligomer, initiator, curing agent, or other adequate materials. The characteristics and the materials of the other components of the reflective liquid crystal display device 100 could be referred to the illustrated contents that are omitted herein. It is appreciated that, the second substrate 120 may include an ultraviolet barrier substrate to filter the ultraviolet light or light in the specific wavelength range. Accordingly, the second cholesteric liquid crystal CH2 and the third cholesteric liquid crystal CH3 being light reactive could be protected from being exposed by the illustrated light again, so that the display quality and the reliability of the reflective liquid crystal display 100 could be improved.

Please refer to FIG. 8 again. FIG. 8 is a cross-sectional view illustrating the reflective liquid crystal display device according to another preferred exemplary embodiment of the present invention. As shown in FIG. 8, compared to the illustrated reflective liquid crystal display device 100, the reflective liquid crystal display device 200 further includes an ultraviolet barrier layer 210 disposed on the second outer surface 122 of the second substrate 120 and a light absorbent layer 220 on the first outer surface 112 of the first substrate 110. In this exemplary embodiment, the second outer surface 122 may be a display surface, and the ultraviolet barrier layer 210 is used to filter the ultraviolet light or light in the specific wavelength range in order to avoid influencing the functions of the second cholesteric liquid crystal CH2 and the third cholesteric liquid crystal CH3 being light reactive. Furthermore, the light absorbent layer 220 is used to absorb the light penetrating through the first cholesteric liquid crystal CH1, the second cholesteric liquid crystal CH2 and the third cholesteric liquid crystal CH3 to improve the display quality. Apart from the disposition of the ultraviolet barrier layer 210 and the light absorbent layer 220, the characteristics and the materials of other components of the reflective liquid crystal display device 200 are similar to the reflective liquid crystal display device 100, that are omitted herein.

Please refer to FIG. 9 again. FIG. 9 is cross-sectional view illustrating the reflective liquid crystal display device according to another preferred exemplary embodiment of the present invention. As shown in FIG. 9, compared to the illustrated reflective liquid crystal display device 200, the reflective liquid crystal display device 300 further includes an adhesive layer 310 disposed between the first substrate 110 and the second substrate 120 in order to strengthen the pasting of the first substrate 110 and the second substrate 120. The adhesive layer 310 could be made of epoxy, acrylic or other adequate and adhesive transparent material. In this exemplary embodiment, the adhesive layer 310 could be disposed between the patterned separation structure 150 and the second electrode 140. Furthermore, in the other exemplary embodiments, the adhesive layer 310 could be disposed between the first electrode 130 and the patterned separation structure 150. Apart from the disposition of the adhesive layer 310, the characteristics and the materials of other components of the reflective liquid crystal display device 300 are similar to the reflective liquid crystal display device 200, that are omitted herein.

In conclusion, in the photoreactive cholesteric liquid crystal of the present invention, the photoreactive cholesteric liquid crystal is implemented to simplify manufacturing process, and the non-photoreactive cholesteric liquid crystal is also utilized to enhance the display properties of the reflective liquid crystal display device. Furthermore, the disposition of the ultraviolet barrier layer or the ultraviolet barrier substrate may prevent the cholesteric liquid crystal having the characteristic of being light reactive from being modified again; accordingly, the reliability of the reflective liquid crystal display device implementing the cholesteric liquid crystal can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of manufacturing a reflective liquid crystal display device, comprising:
providing a first substrate and a second substrate;
forming a patterned separation structure on the first substrate or on the second substrate;
combining the first substrate and the second substrate to dispose the patterned separation structure between the first substrate and the second substrate to form a first channel having a first injection inlet, a second channel having a second injection inlet and a third channel having a third injection inlet;
filling a first cholesteric liquid crystal into the first channel through the first injection inlet, and sealing the first injection inlet, wherein the first cholesteric liquid crystal is used to reflect a first primary color;
filling a second cholesteric liquid crystal into the second channel and the third channel respectively through the second injection inlet and the third injection inlet, and sealing the second injection inlet and the third injection inlet, wherein the second cholesteric liquid crystal is used to reflect a second primary color and the second cholesteric liquid crystal comprises a photoreactive cholesteric liquid crystal; and
performing an exposure process on the second cholesteric liquid crystal in the third channel to modify the second cholesteric liquid crystal in the third channel into a third cholesteric liquid crystal, wherein the third cholesteric liquid crystal is used to reflect a third primary color.

2. The method of manufacturing the reflective liquid crystal display device according to claim 1, wherein the first cholesteric liquid crystal comprises a non-photoreactive cholesteric liquid crystal.

3. The method of manufacturing the reflective liquid crystal display device according to claim 1, wherein an opening direction of the first injection inlet is different from an opening direction of the second injection inlet and an opening direction of the third injection inlet.

4. The method of manufacturing the reflective liquid crystal display device according to claim 1, wherein the exposure process comprises an ultraviolet illuminant exposing the second cholesteric liquid crystal in the third channel.

5. The method of manufacturing the reflective liquid crystal display device according to claim 4, further comprising forming an ultraviolet barrier layer on a second outer surface of the second substrate.

6. The method of manufacturing the reflective liquid crystal display device according to claim 4, wherein the ultraviolet illuminant exposes the second cholesteric liquid crystal in the third channel through the first substrate, and the second substrate comprises an ultraviolet barrier substrate.

7. The method of manufacturing the reflective liquid crystal display device according to claim 1, further comprising forming a light absorbent layer on a first outer surface of the first substrate.

8. A reflective liquid crystal display device, comprising:
a first substrate;
a second substrate, disposed oppositely to the first substrate, wherein a first inner surface of the first substrate and a second inner surface of the second substrate face each other;
a first electrode, disposed on the first inner surface of the first substrate;
a second electrode, disposed on the second inner surface of the second substrate;
a patterned separation structure, disposed between the first substrate and the second substrate to form a first channel and a second channel between the first substrate and the second substrate;
a first cholesteric liquid crystal, disposed in the first channel, wherein the first cholesteric liquid crystal is used to reflect a first primary color and the first cholesteric liquid crystal comprises a non-photoreactive cholesteric liquid crystal; and
a second cholesteric liquid crystal disposed in the second channel, wherein the second cholesteric liquid crystal is used to reflect a second primary color and the second cholesteric liquid crystal comprises a photoreactive cholesteric liquid crystal.

9. The reflective liquid crystal display device according to claim 8, further comprising a third cholesteric liquid crystal, wherein the patterned separation structure further forms a third channel between the first substrate and the second substrate, the third cholesteric liquid crystal is disposed in the third channel, the third cholesteric liquid crystal is used to reflect a third primary color, and the third cholesteric liquid crystal comprises a photoreactive cholesteric liquid crystal.

10. The reflective liquid crystal display device according to claim 8, further comprising an ultraviolet barrier layer disposed on a second outer surface of the second substrate.

11. The reflective liquid crystal display device according to claim 8, further comprising a light absorbent layer disposed on a first outer surface of the first substrate.

12. The reflective liquid crystal display device according to claim 8, wherein the second substrate comprises an ultraviolet barrier substrate.
